(19) United States
(12) Patent Application Publication
(10) Pub. No.: US 2014/0208399 A1
(43) Pub. Date: Jul. 24, 2014

(54) METHOD AND SYSTEM FOR ACCESSING A COMPUTING RESOURCE

(71) Applicant: Frank J. Ponzio, JR., Mantoloking, NJ (US)

(72) Inventor: Frank J. Ponzio, JR., Mantoloking, NJ (US)

(21) Appl. No.: 14/226,155

(22) Filed: Mar. 26, 2014

Related U.S. Application Data
(63) Continuation-in-part of application No. 13/920,488, filed on Jun. 18, 2013.
(60) Provisional application No. 61/662,963, filed on Jun. 22, 2012.

(51) Int. Cl. H04L 29/06

(52) U.S. Cl. CPC H04L 63/10
USPC 726/4

(57) ABSTRACT

Access to a computing resource or service, to gain access to the computing resource or service is defined by access parameters contained in a certificate accessible by an access controller (which can also be referred to as a Unit-of-Use Controller). Identification data associated with a user is provided by a computer-controlled device to the access controller, which retrieves the certificate related to the identification data. The access controller then obtains the access parameters from the certificate and grants access to the computing resource for the user associated with the certificate as a function of the access parameters.

### CROSS REFERENCE TO RELATED APPLICATIONS

This is a Continuation-in-Part of U.S. patent application Ser. No. 13/920,488 filed Jun. 18, 2013, which claims the benefit of priority of U.S. Provisional Patent Application No. 61/662,963 filed Jun. 22, 2012. The contents of U.S. Ser. No. 13/920,488 and of U.S. 61/662,963 are fully incorporated herein by reference in their entirety.

### FIELD

The present disclosure relates generally to controlling access to computing resources. In particular, the present disclosure relates control access to cloud-based computing resources.

### BACKGROUND

Many computing resources, such as, but not limited to, specialized programs, increased bandwidth, cloud-base services, and increased storage space are often required by a user that may be a person or a business, only for a limited period of time or only at periodic intervals.

Providers of computing resources typically have fluctuations in demand for those resources. The fluctuations in demand may have peaks or valleys that occur at periodic times such as nightly, weekly, monthly or annually. At times of low demand, the providers of computing resources may wish to attract more users by offering lower prices, and conversely, at times of high demand they may wish to attract users that are willing to pay a higher price.

Therefore, improvements in promoting and controlling the access of computing resources are desirable.

### SUMMARY

In the present disclosure, a potential user wanting to use a computing resource may first obtain access parameters that define the access, for the user, to the computing resource. The access parameters may be either dynamic utilization constraints or static utilization constraints and each may, for instance, include a temporal utilization constraint or functional use-constraint, or a combination thereof.

In the present disclosure, an access controller may employ the access parameters in one or more utilization methods to control access to the computing resource for a particular user. The access controller may also receive utilization information from the computing resource regarding usage thereof by the user, and may use the utilization information, or utilization data, to update a dynamic utilization constraint associated to the user.

The computing resource may, for instance, include a cloud-based service that may be operable on one or more cloud servers.

In some embodiments, the access parameters may be contained in, or be part of, a certificate (an electronic certificate). The certificate may, for instance, be incorporated into an email, IM or a similar message medium that may be electronically delivered to a user's computer-controlled device, via a private or public electronic communications network.

In some embodiments of the present disclosure there is provided access to a computing resource under constraints that may include an allowed time or date of access.

In further embodiments of the present disclosure, there is provided access to a computing resource under constraints that may include only allowing use of a subset of the total functionality of the computing resource.

In some embodiments, the computing resource is a cloud computing resource. That is, the computing resource is remote and separate from the computer-controlled device used by the user to connect to the computing resource. In other embodiments, the computing resource may be partially resident in a cloud server.

In some of the embodiments, utilization data regarding the utilization of the computing resource by the user can be used to modify/update the access parameters in a certificate associated with the user.

In a first aspect, there is provided a tangible, non-transitory computer-readable medium having recorded thereon instructions to be carried out by processor to perform a method of accessing a computing resource. The method comprises, at a server: receiving identifier data; obtaining access parameters, for a computing resource, as a function of the identifier data; and providing access to the computing resource in accordance with the access parameters.

In a second aspect, there is provided a server comprising: a processor; and a tangible, non-transitory computer-readable medium having recorded thereon instructions to be carried out by processor to perform a method of accessing a computing resource, the method comprising: receiving identifier data; obtaining access parameters, for a computing resource, as a function of the identifier data; and providing access to the computing resource in accordance with the computing resource access parameters.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1A shows an embodiment of a system in accordance with the present disclosure.

FIG. 1B shows another embodiment of a system in accordance with the present disclosure.

FIG. 1C shows yet another embodiment of a system in accordance with the present disclosure.

FIG. 2 shows an embodiment of an access controller in accordance with the present disclosure.

FIG. 3 shows a flowchart of a method according to certain examples of the present disclosure.

FIG. 4 shows a flowchart of another method according to certain examples of the present disclosure.

FIG. 5 shows an Open Systems Interconnection (OSI) type model in accordance with certain examples of the present disclosure.

FIG. 6 shows a block diagram example of an issuer of certificates operationally connected to a certificate source and to a computer-controlled device in accordance with certain examples of the present disclosure.

### DETAILED DESCRIPTION

Generally, the present disclosure relates to a method and system for providing access and control of computing resources. Access, by a user, to computing resources is provided by an access controller. The access controller may be operationally connected to the computing resources. The identification data associated with a user is provided to the access controller, and the access controller locates a certificate associated with the identification data. Access parameters are retrieved by the access controller from the certificate and access to the computing resources is provided for the user as per the access parameters. The access parameters of the certificate can be updated by the access controller after use of the computing resources by the user. Updates to the access parameters can reflect the utilization, by the user, of the computing resources.

In the present disclosure, elements in a network can be said to be operationally connected to each other when, for example, information in one element can be communicated to another element through the network. Further, elements in a network can be said to be operationally connected when an action in, or a state of, one element can be controlled by, or related to, an action in, or a state of, another element.

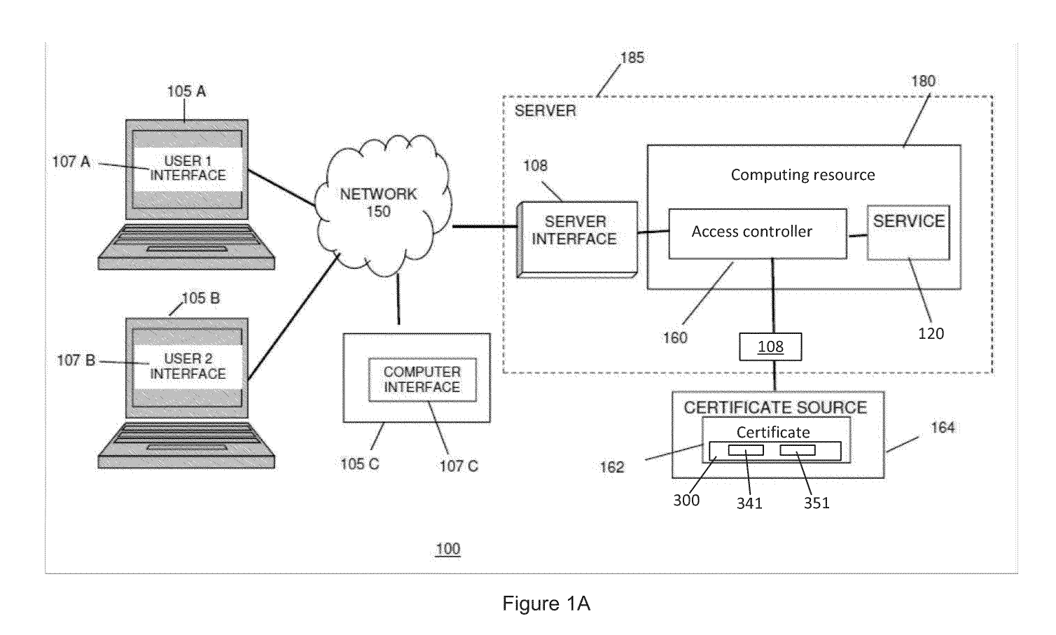

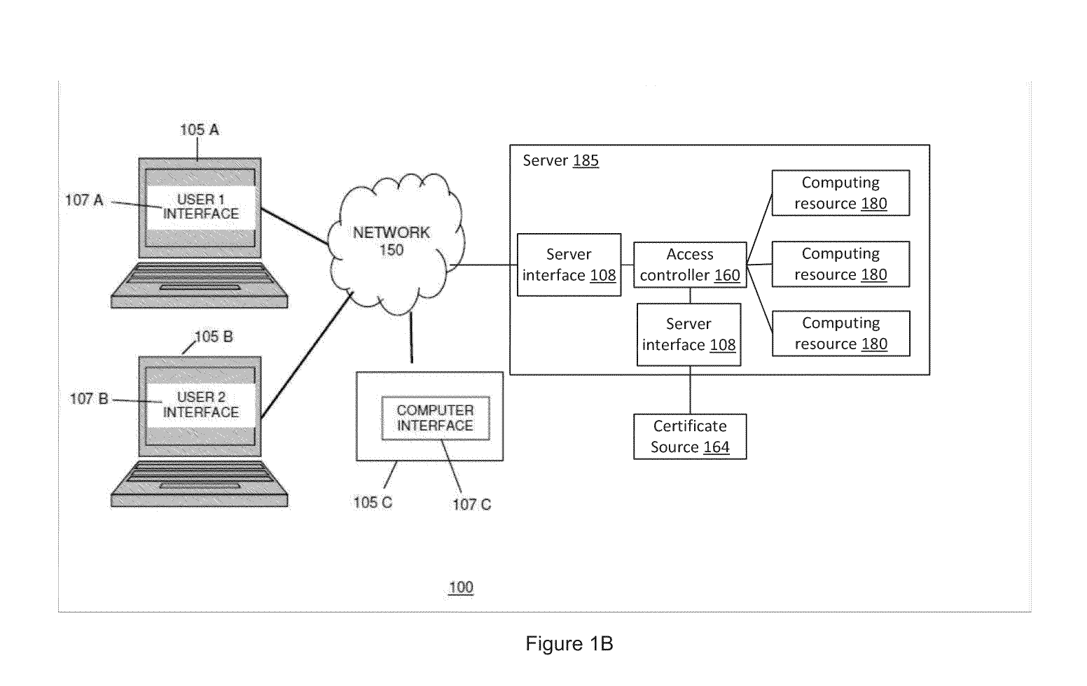

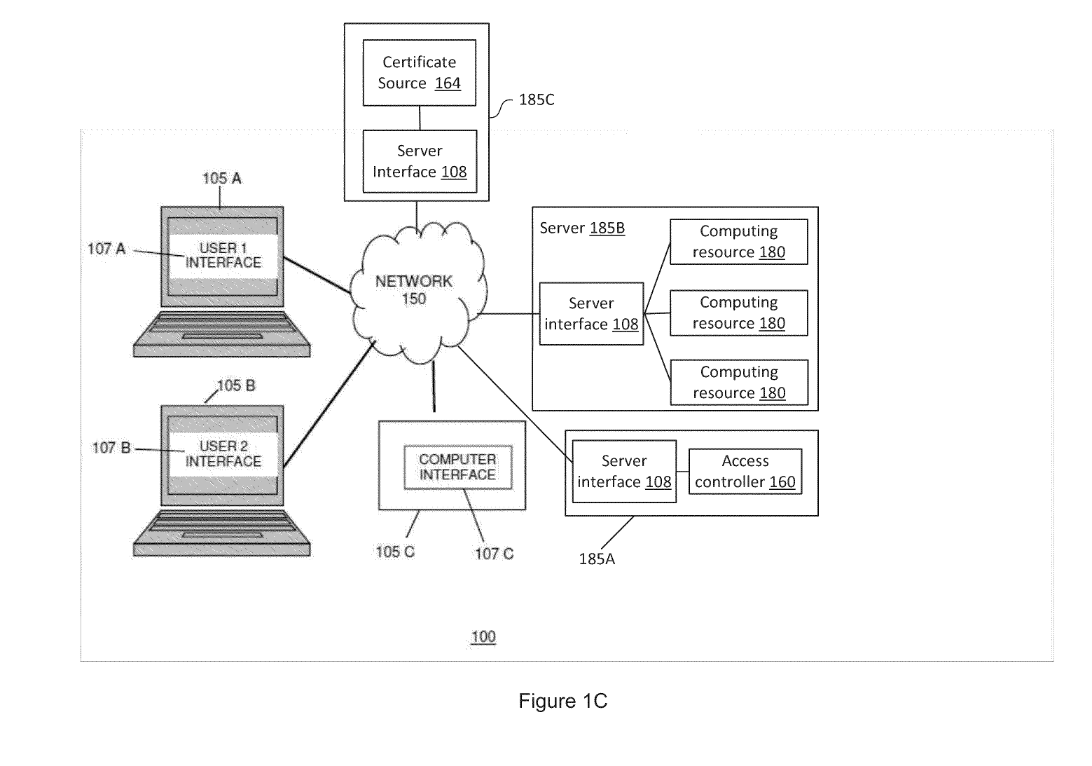

FIG. 1A shows an embodiment of a system 100 in accordance with the present disclosure. The system 100 controls the access, for a user, to a computing resource 180. In the context of the present disclosure, a computing resource can include any type of computer, computing equipment, software, and firmware, or combination thereof. In accordance with the present disclosure, a computing resource can also include any type of service or cloud-based service that can be provided by computers, computing equipment, software, and firmware, or various combinations thereof. In the example shown in FIG. 1A, the computing resource 180 includes, amongst others, a cloud-based service 120. The system 100 includes an access controller 160, which controls access to the computing resource 180 and the cloud-based service 120. Platform as a service, software as a service, and infrastructure as a service are also examples of computing resources comprised within the scope of the present disclosure.

The exemplary system 100 can include one or more computer-controlled devices. In the present example, only three such computer-controlled devices 105A, 105B, and 105C are shown. Each of the computer-controlled devices 105A, 105B, and 105C has a respective user interface 107A, 1078, and 107C, which can also be referred to as computer interfaces. The computer controlled devices 105A, 1058, and 105C may include any suitable electronic communications or processing device such as, for example, a desktop computer, a laptop computer, a tablet device, a smartphone, an e-book reader, a game playing device, PDA, etc. The computer-controlled devices 105A, 1058, and 105C are operationally connected to a communication network 150, through any suitable type of connection, including, for example, wired, wireless, or optical connections, or a combination thereof. The communication network 150 is operationally connected to a server 185, through a server interface 108. The computer-controlled devices provide access, for a user, to the computing resource.

In the example of FIG. 1A, the server 185 includes the computing resource 180 and an access controller 160 that controls access, for a user, to the computing resource 180 and to the cloud-based service 120. Being granted access to the computing resource is to be understood as meaning being able to use the computing resource for its designed purpose or purposes. Accessing the access controller 160, which is, in this example, is shown as being part of the computing resource does not constitute in itself an access to the computing resource. The access controller 160 is operationally connected to a certificate source 164, through a server interface 108. The certificate source 164 (or certificate store) can include one or more than one certificates 162.

While the access controller 160 is shown as being part of the server 185 and part of the computing resource 180, in alternative embodiments of the system 100, the access controller 160 may be inside the server 185 and outside the three computing resources 180, as shown in FIG. 1B. In the embodiment shown in FIG. 1B, the access controller 160 controls access to the three computing resources 180.

Embodiments where the access controller 160 is disposed outside the server 185, for example, in another server are also within the scope of the present disclosure. For example, FIG. 1C shows another embodiment of the system 100 in which the access controller 160 is located in a first server 185A and controls access to computing resources 180 located in a second server 185B. A certificate source 164 is located in a third server 185C that interfaces with the network 150 through a server interface 108. Communication between servers 185A, 185B, and 185C is shown as occurring through the network 150. Further, embodiments with multiple certificate sources 164, operationally connected to one or multiple access controllers, are also within the scope of the present disclosure.

With respect to the certificate source 164, although the certificate server 164 is shown disposed or located in a third the server 185C, in alternative embodiments, the certificate source 164 can be located, for example, in the access controller 160 itself, in the server 185B which is outside the access controller 160, or in the computing resource 180 itself. Further embodiments, where the certificate source 164 is disposed within the server 185, or within another server operationally connected to the access controller 160, are also within the scope of the present disclosure. Although only two server interfaces 108 are shown in FIG. 1A, servers with any number of server interfaces, interfacing with one or more networks or devices are also within the scope of the present disclosure.

The user interfaces 107A, 107B, and 107C may be implemented as any suitable type of interface such as, but not limited to, a touch screen menu, a mouse accessible hierarchical menu, a list or a graphic layout, etc. The user interfaces 107A, 107B, and 107C may, for instance, enable interaction between a user and the system 100. For example, by using the user interfaces 107A, 107B, and 107C, the user may interact with the server 185, the computing resource 180, and the cloud-based service 120, which, in FIGS. 1A, 1B, and 1C is part of the computing resource 180. The user interfaces 107A, 107B, and 107C may, for instance, be implemented as suitable software modules such as, but not limited to, a browser or a client application, or some combination thereof.

The server interfaces 108 may be implemented in any suitable way, such as by, for example, as an application programming interface (API) that may be part of, or may have access to, the access controller 160 and the computing resource 180.

With references to FIGS. 1A, 1B, and 1C, and in accordance with certain embodiments, a user, through the computer-controlled device 105A accesses the computing resource 180, which can include a cloud based service 120. The access controller 160 controls access to the computing resource 180. Such access may be determined, in part, by access parameters 300 (or access permissions) comprised in a certificate 162 (an electronic certificate) stored in the certificate store 164. The user, through the computer-controlled device 105A enters identification data, which is provided to the access controller 160 by the computer-controlled device 105A. The access controller 160, using the received identification data, identifies a pre-established certificate 162 belonging to, or associated with, the user. Once identified, the certificate 162, or the access parameters 300 contained therein, or both, can be retrieved by the access controller 160. In some embodiments, the certificate 162 must be compliant with existing certificate standards.

The access parameters 300 may include or may define utilization constraints (computing resource utilization constraints) that may, for instance, be static, dynamic or a combination thereof. With reference to FIG. 1A, a static utilization constraint 351 may, for instance, be a predetermined, unalterable utilization constraint, such as, but not limited to, always only being able to access the computing resource 180 (or service 120 included in the computing resource 180) at a particular time of day, or always only being able to access a certain limited level of functionality of the service 120 or computing resource 180. In some embodiments, same services 120 or computing resources 180, but with different levels of functionality, can be defined as separate services or separate computing resources each having its own web address or URL (uniform address locator).

A dynamic utilization constraint 341 may be a constraint that the access controller 160 may alter after time, or after utilization of the computing resource 180 (or service 120 included in the computing resource 180). A dynamic utilization constraint 341 may, for instance, include a condition such as, but not limited to, a level of functionality of the service that increases with number of utilizations of the computing resource 180 by the user, a level of functionality of the service that increases with the proficiency of the user at using the computing resource 180, or it may include a condition, such as, but not limited to, changing the time of access dependent on the frequency of access to the system 100 or the computing resource 180 by the user. The dynamic utilization constraint 341 may be modified, as will be described below, as a function of utilization data provided by the computing resource 180 to the access controller 160, subsequent utilization of the computing resource 180 by the user.

Both the static utilization constraint 351 and dynamic utilization constraint 341 may include conditions that may be classified as temporal utilization constraint or functional utilization constraint, or some combination thereof.

As further non-limiting examples, the utilization constraints of the access parameters 300 may contain conditions of use such as, but not limited to, an allowed time or date of access to the computing resource 180, an allowed frequency of access to the computing resource 180, an allowed number of accesses to the computing resource 180, or any suitable combinations thereof. The access parameters 300 may also include pricing data related to the utilization of the computing resource 180. The pricing data may be a function of, for example, the amount of memory used, the bandwidth, the software application used, the access to specific files, the access to a particular media resource or some combination thereof. The price, or value, of the access certificate 162 may depend on factors such as, but not limited to, the date or time period of permitted use, the number of prior uses, the number of purchased uses, a remaining number of future uses, or some combination thereof. Further, the access parameters can include an identification of the resources or resources that can be accessed by the user. Depending on the access parameters, different versions of same software (same computing resource or service) can be accessible to the user. These different versions of the same resource can be identified, in the access parameters 300, by different names, web addresses, or URLs.

The purchasing or obtainment of the access certificate 162 can be achieved through any suitable manner. For example, a computing resource or computing service owner may authorize or hire a ticket-issuing, ticket-selling, or coupon-issuing enterprise to provide (issue and/or sell) certificates 162, using the enterprise's own facilities/equipment, to users or potential users of the computing service or computing resource.

In the embodiment of FIG. 1A, the access controller 160 defines a single node through which pass all requests for accessing the computing resource 180.

In some embodiments, the certificate source 164 can be mined, in any suitable manner, for data relating to the use of the computing resources defined in the certificates comprised in the certificate source.

The computing resource 180 may be implemented as a web site or a portal that interconnects with the access controller 160.

The computing resource 180 may provide platform resources in the form of information processors such as, but not limited to, computers, servers, blade servers, or combinations thereof. These platform resources may be available, for example, as a client server or a web service. The computing resource 180 may also have a variety of capabilities, such as, but not limited to, processing speed, memory capacity, storage capacity, and network bandwidth, i.e., bandwidth to and/or from network 150. Moreover, the computing resource 180 may charge a variety of associated costs that may be denominated in an suitable currency, such as, for example, US dollars, euros, yen, etc., that are charged to a user to utilize the computing resource 180.

In some embodiments, the computing resource 180 may connect with the access controller 160 to access identifier data associated with the user, the certificate 162, or both to monitor and meter the costs and services that are accessed by the user.

In some embodiments, the computing resource 180 may be located at a server facility (not shown) that provides the computing resource 180 on a rental or for hire basis to the provider of the services hosted by the computing resource 180.

In some embodiments, the communication network 150 may be a communication network. One of ordinary skill in the art will, however, appreciate that aspects of the present disclosure may be implemented with minimal modification on any suitable communications networks, or otherwise directly connected devices and may include, alone or in any suitable combination, intra-process communication, the Internet, an intranet, a telephony-based network, a local area network (LAN), a wide area network (WAN), a dedicated intranet, a wireless network, and a bus.

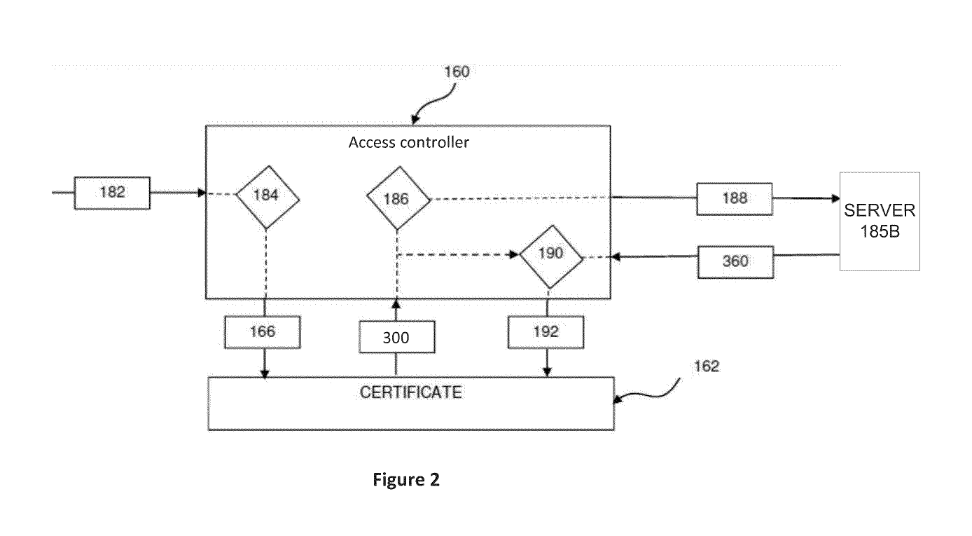

FIG. 2 shows a schematic view of the interactions of the access controller 160 with the certificate 162. In the example of FIG. 2, the access controller 160 receives identifier data 182, for a user, from, now with reference to FIGS. 1A, 1B, and 1C, one of the computer-controlled device 105A, 105B, of 105C, though the network 150 and the server interface 108 connected to the network 150. The identifier data 182 may, for instance, contain information such as, but not limited to, a user name, a password, a discount coupon or offer, biometric identifiers, barcodes, an identification of a certificate 162, or some combination thereof.

Referring again to FIG. 2, the access controller 160 can use the identifier data 182 to determine, with a gate keeper module 184 that may, for instance, be operable on the access controller 160, access parameters to a computing resource. A user name and password may, for instance, be used in a manner consistent with well know password verification in which the submitted user name and password are searched for on one or more essentially static registers and, if located and found to be matching, further processing allowed. Biometric identifiers, barcodes and other forms of identification can supply identifier data 182 to the access controller 160. If such an identifier is desired to be used, optical sensors such as scanners, cameras, and the like or some combination thereof may be used to facilitate the identification process. Depending on the source of the identifier data, it can be more readily ascertained who is attempting to access the computing resource 180 in question.

A certificate identifier 166 can be used by the access controller 160 to locate the certificate 162 associated with the identifier data 182. The certificate identifier 166 may be a module running on the access controller 160 or it may operate external to the access controller 160 as shown in FIG. 2.

As stated above, the certificate 162 may, for instance, have access parameters 300 indicating when, how, and to what extent or functionality level a computing resource can be used by the user to whom the certificate 162 is associated. The access parameters 300 may, for instance, be dynamic or static as described above. The access parameter 300 may be passed on from the certificate 162 to the access controller 160 as shown in FIG. 2, or they may be read off the certificate 162 by a level of access module 186. The access parameters 300 may also be passed to, or read by, a certificate change check module 190, whose functionality is described further below.

The access controller 160 may also function to supply the access parameters both to the level of access module 186 for immediate processing and to the certificate change check module 190 for later processing.

The level of access module 186 can compare the access parameters 300 to relevant facts such as, but not limited to, the date, time, and current utilization of the computing resource or some combination thereof. The level of access module 186 may then issue permissions for allowed access 188 that effectively grant access to the computing resource 180 for the user. The level of access given to the user can be determined in part by the access parameters 300, by the number of prior uses of the computing resource, and in part by current system variables or data such as, but not limited to, utilization, date, time, anticipated system utilization or some combination thereof.

The access controller 160 may receive utilization data 360 from the computing resource being used, or the certificate change check module 190 may actively obtain (request) utilization data 360 from the computing resource being used. The computing resource may be part of, or be operationally connected to the server 185B, also shown at FIG. 2. The utilization data 360 may be processed by the certificate change check module 190 along with any relevant access parameters 300 that may have been received earlier. Based on a comparison of the utilization data 360 and the access parameter 300, the certificate change check module 190 may then issue a certificate change list 192 for any dynamic use-constraint 341, comprised in the access parameters 300 that may require updating or alteration. The certificate change list 192 may, for instance, contain one or more updates to the access parameters 300 that may be recorded on the certificate 162 in anticipation of future attempts by the user to obtain access to the computing resource by means of the access controller 160 and the certificate 162. For example, if the access parameters 300 of the certificate 162 specified, prior to the user requesting connection to the computing resource, that the number of accesses by the user to the computing resource was 10, then, subsequent the use of the resource, or after initiation of access to the computing resource, the utilization data 360 sent to, or obtained by, the change check module 190 would be 1 use of the computing resource, and the number of remaining accesses specified in the certificate would be reduced to 9.

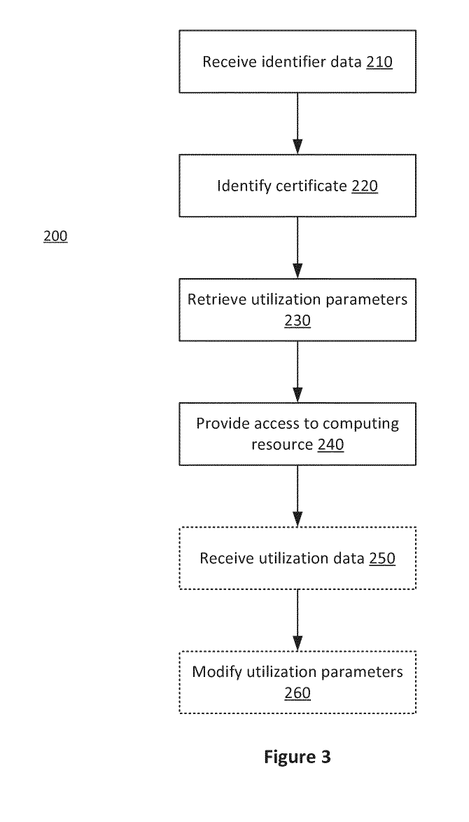

FIG. 3 shows a flowchart of method 200 according to certain examples of the present disclosure. The flowchart example of FIG. 3 relates to the access controller 160 (shown at FIGS. 1A and 2) determining or obtaining the access parameters 300 (shown at FIGS. 1A and 2) based upon identification data such as, for example, a user identifier, a password, a coupon, or an identification of the certificate. FIG. 3 also relates to the access controller 160 receiving utilization data from the computing resource 180 (shown at FIG. 1A) and updating (modifying) the access parameters of the certificate 162.

At action 210, the access controller 160, or more generally, the server 185 on which the access controller is located, receives identifier data 182 that identifies a user who wishes to use the computing resource 180. The identifier data can be provided to the server 185 or access controller 160 from a computer-controlled device (shown at, for example, reference numeral 105A of FIG. 1A), through any suitable communication path operationally connecting the computer-controlled device to the server 185 or access controller 160.

At action 220, the access controller 160, or more generally, the server 185, identifies a certificate 162 in accordance with the identifier data 182 received at action 210. Additionally, the user may be prompted to provide complementary identification data such as, for example, a personal identification number (PIN) via, for example, the user interface 107A.

At action 230, the access controller 160, or more generally, the server 185, retrieves, from the certificate 162, an access parameter or several access parameters 300. The access parameters 300 may, for instance, indicate the date and time period for which use of the computing resource 180 is permitted, how many uses of computing resources are permitted, and the charges for, or the value of, a unit of use of the computing resource 180.

At action 240, the access controller 160, or more generally, the server 185, provides access to the computing resource 180, in accordance with the access parameters obtained at action 230. The access controller 160 can provide access to the computing resource 180 by connecting the computer-controlled device 105A, 1056, 105C to the host address of the computing resource 180. The computing resource 180 can be a public computing resource, generally accessible by all, or a private computing resource, generally locate in a private network. For security reasons, any private computing resource that is made available to the public can be given a pseudo-name that is mapped to a resource name and hosting address (URL).

At action 250 the access controller 160, or more generally, the server 185 on which the access controller 160 is located, may receive utilization data 360 from the computing resource 180. The utilization data 360 may indicate when and/or how the access parameters 300 (or the certificate 162) were use. For example, the utilization data 360 may indicate, a date and time of day the certificate was used, the duration of use, the type of use, the services used, the level of functionality used, the bandwidth used, the memory used, etc.

At action 260 the access controller 160 may access and modify (or update) the certificate 162 in accordance with the utilization data 360 received at action 250. The access controller 160 may record or encode some or all of the utilization data 360 received from the computing resource 180 on or in the certificate 162 such as by modifying the access parameters 300. Once the access parameters 300 have been modified, they can be said to include historical data relating to the use of the certificate 162.

Further, the certificate 162 and its access parameters 300 can determine the behavior of the access controller 160. That is, depending on the access parameters 300 retrieved by access controller 160, some of the functions of the access controller can be selected or not (or turned on or off). Such functions may relate to the level of functionality of the computing resource 180. For example, in some embodiments, the access controller 160 may be operable to provide access to a certain number of levels of functionality of a particular computing resource (or service). If the access parameters indicate that only a basic level of functionality is to be provided to the user of the certificate, then the access controller selects only that basic level of functionality, essentially turning off all other levels. The computing resource can then connect the user to the computing resource that has the aforementioned basic level of functionality.

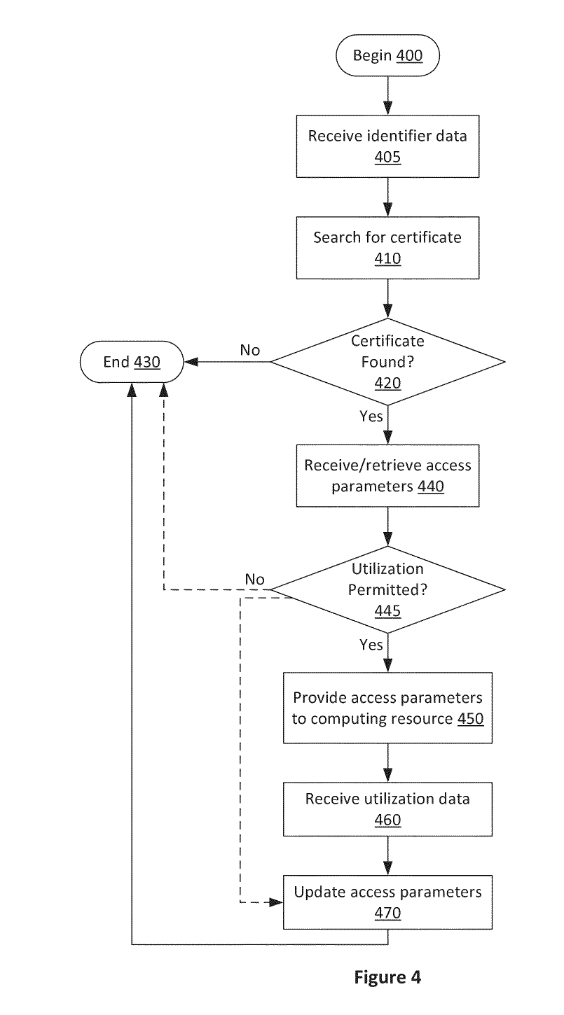

FIG. 4 is a flowchart of another method according to certain embodiments of the present disclosure. The method of FIG. 4 begins at reference numeral 400. Referring to FIG. 4 and FIG. 1A, at action 405 the access controller 160, or more generally, the server 185 on which the access controller 160 is located, receives identifier data 182 that identifies a user who wishes to use the computing resource 180. The identifier data can be provided to the server 185 or access controller 160 from a computer-controlled device (shown at, for example, reference numeral 105A of FIG. 1), through any suitable communication path operationally connecting the computer-controlled device to the server 185 or access controller 160.

At action 410, the access controller 160, or more generally, the server 185, accesses the certificate source 164 and attempts to locate a particular certificate 162 based upon (in accordance with, as a function of) the identifier data 182 received at action 405.

At action 420, it is determined if the certificate 162 has been found. If the certificate 162 has not been found, the method ends at reference numeral 430. If the certificate 162 has been found, the method proceeds to action 440 where the access parameters 300 or the certificate 162 are retrieved. At action 445, the access parameters 300 are subject to an initial check that compares the access parameters 300 to, pre-determined criteria to determine if the access parameters 300 can be used to the access the computing resource 180. For example, the access parameters 300 can be compared to pre-determined criteria such as pre-determined access dates and/or pre-determined time periods to determine if the access parameters 300 can be used to the access the computing resource 180 at the current date and/or time.

If, at action 445, it is determined that access cannot be granted to the computing resource 180, the method can end at 430 or, the method can proceed to action 470 to update the access parameters, to indicate a failed attempt to connect to the computing resource 180 (too many failed attempts at using the computing resource may indicate a nefarious attempt at using the computing resource). Conversely, if, at action 445, it is determined that access can be granted to the computing resource 180, the method proceeds to action 450 where the access controller 160, or more generally, the server 185, provides the access parameters 300 to the computing resource 180, which grants access to the computing resource 180.

At action 460 the access controller 160 can, in some examples, receive utilization data 360 from the computing resource 180 or from the server 180 that may be hosting the computing resource. For example, the access controller 160 may receive utilization data 360 that indicates when the certificate 162 (or its access parameter 300) was utilized and how it was utilized.

At action 470 the access controller 160 may access and modify (or update) the certificate 162 in accordance with the utilization data 360 received at action 250. The access controller 160 may record or encode some or all of the utilization data 360 (see FIG. 2) received from the computing resource 180 on or in the certificate 162. For example, the access controller 160 may receive information from the computing resource 180 indicating when and how the certificate 162 (and access parameter 300) was used.

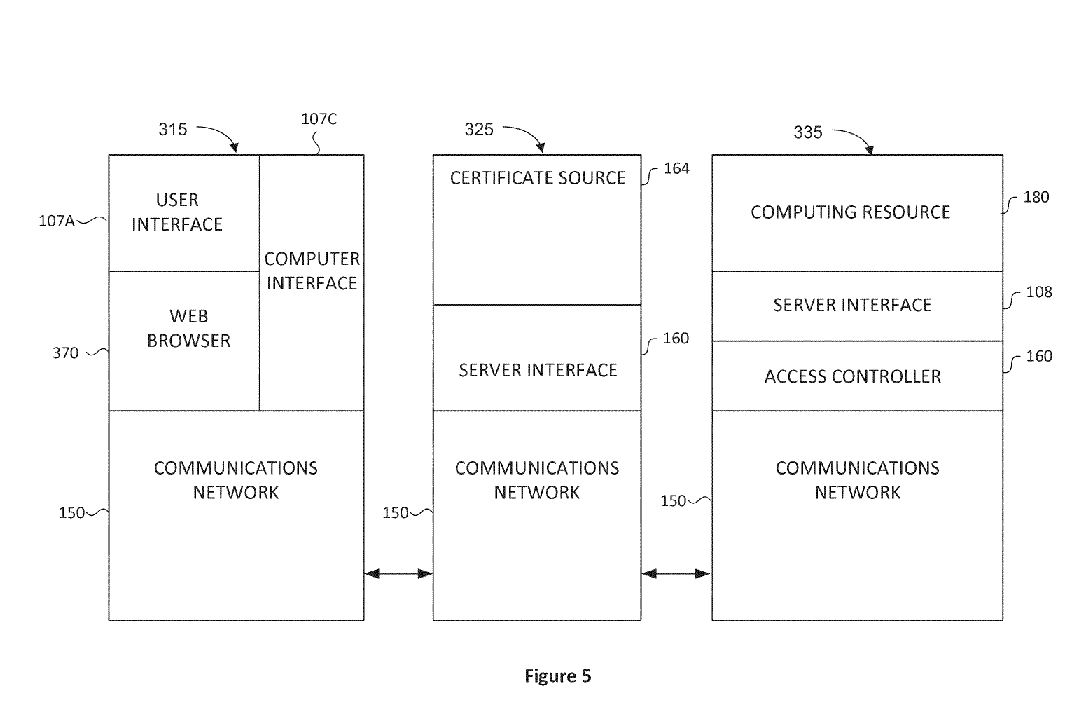

FIG. 5 shows an example of a simplified Open Systems Interconnection (OSI) type model that depicts some interconnections that occur in and between a user platform 315, a certificate provider platform 325 and a computing resource provider platform 335.

The user platform 315, the certificate provider platform 325 and the computing resource platform 335 may, for instance, only communicate at the network layer (OSI layer 3) with data in the form of packets carried on the data link (OSI layer 2) and the physical layers (OSI layer 1), both of which may form part of the communications network 150 shown in, for example, in FIG. 1C.

The user platform 315 includes the user interface 107A of the computing resource 105A shown in FIG. 1C, which may encompass OSI layers 5-7 (i.e., the session, presentation and application layers). The user interface 107A communicates with the communications network 150 through a web browser 370. The web browser 370 may encompass OSI layers 6 and 7 (i.e., the presentation and application layers). The user platform 315 also includes the computer interface 107C of the computing resource 105C, as shown in FIG. 1C. The computer interface 107C communicates directly with the communications network 150 and may also encompass OSI layers 6 and 7.

As noted above, the certificate provider platform 325 communicates with the user platform 315 at the network layer through the communications network 150. The certificate provider platform 325 includes a server interface 160 that enables communication between the certificate source 164 and the communications network 150. The certificate provider platform 325 may encompass OSI layers 6-7.

The computing resource provider platform 335 communicates with the user platform 315 and the certificate provider platform 325 at the network layer through the communications network 150. The computing resource provider platform 335 includes the access controller 160, the server interface 108, and the computing resource 180. The access controller 160 communicates with the computing resource 180 via the server interface. In an embodiment, the computing resource 180 may encompass OSI layers 5-7, and the access controller 160 may reside in layers 6 and 7. The communications network 150 may reside primarily in OSI layer 5.

The OSI layer 4 (transport layer) provides for the transference of packets between points on the communications network 150. The transport layer will help to ensure adequate delivery of information to the computing resources 105A-C attempting to access the computing resources 180. The transport layer may provide, but is not limited to, connection oriented communication, multiplexing, flow control, congestion avoidance, and reliability, or any combination thereof providing an efficient user experience.

A certificate 162 may for instance, be purchased in advance, and may provide access to a computing resource under specified limitations. These limitations may be either static or dynamic, or some combination thereof. They may, for instance, limit user access to a specific time, a specific length of time, a specific subset of functionality or any other suitable measure of computing resource.

An issuer of the certificate 162 may, for instance, presell user time slots that coincide with their usual, predicted valleys of use at a significant discount to the normal price of use, thereby making money on their otherwise wasted computing resource. Conversely, certificates 162 guaranteeing access at peak times may be sold at a premium.

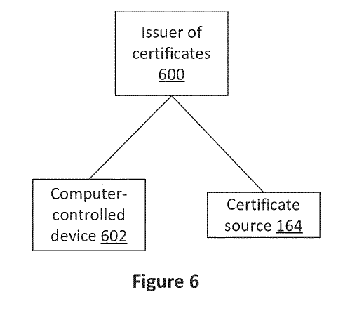

FIG. 6 shows block diagram representing an issuer of certificates 600 operationally connected to a certificate source 164 to provide to the certificate source 164 one or more certificates granting access to one or more computing resources. The issuer of certificates 600 is also shown operationally connected to a computer-controlled device 602 accessible by a user. The issuer of certificates 600 can issue a certificate by sending the certificate to the certificate source 164 and by issuing identification data, required by the user to access the certificate, to the computer-controlled device 602. The computer-controlled device can be a personal computer, a smartphone, a tablet, a gaming device, or any other suitable type of computer-controlled device that can communicate with the issuer of certificates 600. The issuer of certificates 600 can provide the identification data to the computer-controlled device 602 in any suitable way such as, for example, by email, by SMS, by voicemail, etc. Alternatively, in some embodiments, the issuer of certificates 600 may send the certificate only to the computer-controlled device 602. In such embodiments, the user wanting to access the computing resource specified in the certificate would simply provide the certificate the access controller associated to the computing resource in question and the user would be granted access as specified by the certificate. After utilization of the computing resources, the access parameters of the certificate could be changed in accordance with how and when the certificate was used, and send back to the user for future use by the user. Moreover, certificates 162 may be used by third parties as, for instance, rewards or gifts that may, for instance, be part of promotional campaigns for non-computer merchandise or services. As a specific, but in no way limiting example, 5 hours use of high end editing software with every purchase of a particular digital camera.

The present disclosure provides several advantages that include the following. Access and use of computing resources can be controlled in accordance with pre-determined criteria that can include, for example, calendar dates and time periods. Further, in embodiments where the user provides a certificate identifier to the access controller, there can be no need of login and password steps. Further, a software provider, service provider, or cloud service provider can issue certificates for trial use of their software, service, or cloud-based service. This allows a measure of control on the trial use.

Additionally, the present disclosure is advantageous in that it can provide controlled trial access to a publication/report encompassed in a computing resource (e.g., a memory). Also, the present disclosure can provide a controlled complimentary copy of a document encompassed in a computing resource.

Further, the present disclosure is advantageous in that, in some embodiments, a computing resource can be further monetized by providing discounted use of the computing resource at times where the resource is usually not used. Furthermore, the present disclosure can provide controlled introductory use of an application encompassed within a computing resource.

Also, the present disclosure is advantageous in that it can provide controlled complimentary download of information from a computing resource, by issuing to a user a certificate associated to the downloadable information. The present disclosure can also provide free/complimentary auto inspection services of a user computing equipment, software, or data content, by issuing to the user a certificate to that effect. Any other suitable web service or cloud-based service can be provided to a user using the present disclosure.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A tangible, non-transitory computer-readable medium having recorded thereon instructions to be carried out by processor to perform a method of accessing a computing resource, the method comprising:
at a server:
receiving identifier data associated with a user of a computing resource;
obtaining access parameters for the computing resource as a function of the identifier data; and
providing access to the computing resource in accordance with the access parameters.

2. The tangible, non-transitory computer-readable medium of claim 1 wherein:
the identifier data is received from a computer-controlled device; and
providing access to the computing resource includes operationally connecting the computer-controlled device to the computing resource.

3. The tangible, non-transitory computer-readable medium of claim 1 wherein the method further comprises:
prior to obtaining the access parameters, identifying a certificate as a function of the identifier data, the certificate having the access parameters.

4. The tangible, non-transitory computer-readable medium of claim 3 wherein obtaining the access parameters includes retrieving the access parameters from the certificate.

5. The tangible, non-transitory computer-readable medium of claim 1 wherein the method further comprises:
at the server:
after providing access to the computing resource, receiving utilization data of the computing resource; and
modifying the access parameters in accordance with the utilization data.

6. The tangible, non-transitory computer-readable medium of claim 1 wherein the identifier data includes at least one of a user identifier, a password, a coupon, and an identification of the certificate.

7. The tangible, non-transitory computer-readable medium of claim 1 wherein the access parameters includes an identification of the computing resource.

8. The tangible, non-transitory computer-readable medium of claim 7 wherein the computing resource includes at least one of computing equipment, software, and firmware.

9. The tangible, non-transitory computer-readable medium of claim 8 wherein the computing resource includes a service provided by at least one of the computing equipment, software, and firmware.

10. The tangible, non-transitory computer-readable medium of claim 9 wherein the service is a cloud-based service.

11. The tangible, non-transitory computer-readable medium of claim 10 wherein the access parameters include static parameters that define at least how and when the computing resource can be utilized.

12. The tangible, non-transitory computer-readable medium of claim 5 wherein the access parameters include dynamic parameters that define at least how and when the computing resource can be utilized.

13. The tangible, non-transitory computer-readable medium of claim 12 wherein modifying the access parameters in accordance with the utilization data includes modifying the dynamic parameters.

14. A server comprising:
a processor; and
a tangible, non-transitory computer-readable medium having recorded thereon instructions to be carried out by processor to perform a method of accessing a computing resource, the method comprising:
receiving identifier data associated with a user of the computing resource;
obtaining access parameters as a function of the identifier data; and
providing access to the computing resource in accordance with the access parameters.

15. The server of claim 14 wherein:
the identifier data is received from a computer-controlled device; and
providing access to the computing resource includes operationally connecting the computer-controlled device to the computing resource.

16. The server of claim 14 wherein the method further comprises:
prior to obtaining the access parameters, identifying a certificate as a function of the identifier data, the certificate having the access parameters.

17. The server of claim 16 wherein obtaining the access parameters includes retrieving the access parameters from the certificate.

18. The server of claim 14 wherein the method further comprises:
at the server:
after providing access to the computing resource, receiving utilization data of the computing resource; and
modifying the access parameters in accordance with the utilization data.

19. The server of claim 14 wherein the identifier data includes at least one of a user identifier, a password, a coupon, and an identification of the certificate.

20. The server of claim 14 wherein the access parameters includes an identification of the computing resource.

21. The server of claim 20 wherein the computing resource includes at least one of computing equipment, software, and firmware.

22. The server of claim 21 wherein the computing resource includes a service provided by at least one of the computing equipment, software, and firmware.

23. The server of claim 22 wherein the service is a cloud-based service.

24. The server of claim 23 wherein the access parameters include static parameters that define at least how and when the computing resource can be utilized.

25. The server of claim 18 wherein the access parameters include dynamic parameters that define at least how and when the computing resource can be utilized.

26. The server of claim 25 wherein modifying the access parameters in accordance with the utilization data includes modifying the dynamic parameters.
